(19) United States
(12) Patent Application Publication
(10) Pub. No.: US 2009/0195001 A1
(43) Pub. Date: Aug. 6, 2009

(54) Distance Piece

(75) Inventors: Ulrik Bruhn, Odder (DK); Stig Nielsen, Jels. Rodding (DK)

Correspondence Address: HARNESS, DICKEY & PIERCE, P.L.C., P.O. BOX 8910, RESTON, VA, 20195, US

(73) Assignee: ITOOLS APS, Odder (DK)

(21) Appl. No.: 10/585,952

(22) PCT Filed: Jan. 13, 2005
(86) PCT No.: PCT/DK2005/000017

§ 371 Date: Dec. 5, 2008

(30) Foreign Application Priority Data
Jan. 13, 2004 (DK) PA 2004 00029
May 28, 2004 (DK) PA 2004 00840
Nov. 4, 2004 (DK) PA 2004 01700

(51) Int. Cl. E05C 17/44; E05B 9/00

(52) U.S. Cl. 292/342; 16/404

(57) ABSTRACT

The invention provides a distance piece e.g. to replace a traditional wedge e.g. for fitting a window to an opening of a building. The distance piece has two parts (2, 3) which are separable by a separation part. During use, the separation part is inserted between the two parts which are forced apart. In this condition, the separation part is locked to leave the distance piece in the expanded condition. After final fixation of the building component, the separation part can be released and moved to a position wherein the two parts are allowed to revert to a collapsed state. In that way, the distance piece facilitates reuse.

### INTRODUCTION

The present invention relates to a distance piece, e.g. for use in connection with fitting of pre-fabricated building components such as windows or doors. In particular, the invention relates to a distance piece comprising first and second parts having inner surfaces facing each other and forming walls of a space between the parts, and opposite outer surfaces forming part of an outer surface of the distance piece, the parts being movable relative to each other between a contracted relative position with a shorter distance between the outer surfaces and an expanded relative position with a larger distance between the outer surfaces. To move the parts between the contracted and expanded positions, the distance piece comprises a separation part located between the first and second parts and to secure the parts e.g. in expanded position, the distance piece comprises a lock which hinders movement of the separation part relative to the first and second parts. The distance piece further comprises locking means which can hinder movement of the separation part from the first position to the second position relative to the first and second parts.

### BACKGROUND OF THE INVENTION

Traditionally, building components such as windows and doors are fitted to a building by use of wedges being wedged into a gap between the building and the component. When the component is aligned in the building, final fixation is made in traditional way by use of screws or nails.

Distance pieces or filling chocks have traditionally been made of pieces of trimmed wood. In resent years, however, various wedges made of plastic have been developed, c.f. e.g. EP 08 443444. Since components like windows and doors where previously kept in place by a screw or nail acting on the component in a direction towards the wedge, the wedges had to be left in place after the final fixation. The invention of new location screws which fixate the component in any direction relative to the building has implied new ways of fitting the components and typically, the wedges are removed from the gap as soon as the location screws are attached.

To enable adjustment of the distance between the building and the component, pairs of two wedges are typically inserted in the gap between the building and the component. The wedges are inserted in mutual contact and arranged reversely in respect to each other so that a sharp edge of one wedge is pointing in the direction of a blunt edge of the other wedge. In that configuration, the spacing between the building and the component may be adjusted by hammering on the blunt edge of one of the wedges whereby displacement of one wedge in relation to the other wedge results in formation of a larger gap. During fitting of a component into a building, it can be difficult to keep the wedges in mutual contact, and it often happens that the wedges gets separated and falls out of the gap. It is, furthermore, difficult to exactly adjust the distance between the building and the component precisely.

In U.S. Pat. No. 4,858,865 a wedge operated levelling shoe is disclosed in which a top and a bottom plate are separated by an adjustable distance determined by an intermediate wedge. The parts are maintained aligned by slidable keys and resilient spring elements. A screw is provided to move the wedge relative to the plates. Correspondingly, FR 2 532 641 discloses lifting means with two blocks located on opposite sides of a wedge which is movable by a screw.

The disclosed distance pieces may be suitable for lifting and alignment purposes. E.g. in the process of fitting building components such as windows or door frames to a wall structure, the disclosed levelling devices could be too time-consuming and expensive.

### DESCRIPTION OF THE INVENTION

It is an object of the invention to provide a distance piece which provides a variable distance and which is simple and cheap and fast to operate. Accordingly, the invention provides a distance piece of the kind mentioned in the introduction characterised in that characterised in that locking means comprises at least one configuration in which it permits movement of the separation part from the second position to the first position relative to the first and second parts. Due to the ability of the lock to permit movement from the second position to the first position, a user may fast and easily move the separation part until the distance piece has expanded sufficiently. At this location, the lock may hinder movement in the opposite direction from the first position to the second position. Accordingly, the distance piece is simple, cheap and reliable compared with traditional distance pieces.

In one embodiment, the locking means comprises a lock which is movable between a first position wherein it hinders the movement of the separation part relative to the first and second parts and a second position wherein it does not influence the movement of the separation part relative to the first and second parts.

Due to the two positions of the lock, a user may fast and easily move the separation part until the distance piece has expanded sufficiently. At this location, the lock may be moved to a “locked” position in which the separation part remains in its position relative to the first and second parts. Accordingly, the distance piece is simple, cheap and reliable compared with traditional distance pieces.

During use, the building component, e.g. a window, is aligned in the building and the distance piece is inserted into a gap therein between. In this position, the separation part is moved towards the position wherein the first and second parts are moved sufficiently away from each other to establish contact between the outer surfaces of the first and second parts and the component and the building, respectively. At this point, the lock is moved to the locked position wherein it hinders the movement of the separation part relative to the first and second parts, and the component can be fastened, e.g. in a traditional way by use of location screws. After the final fixation of the component to the building, the lock is moved to the unlocked position in which it does not influence the movement of the separation part relative to the first and second parts, and the separation part is moved back to its previous position, thereby releasing the first and second parts, and the distance piece can be removed for later use in another location. The first and second parts and the separation part could be made of wood or steel or made of a polymeric or ceramic material, e.g. a composite material comprising fibres of glass, carbon or Kevlar™. The first and second parts could be identical parts, e.g. wedge shaped parts formed with a shape which is triangular in one cross-sectional view of the parts.

To enable an easier operation of the distance piece, the separation part may comprise a handle extending outside the space. The handle may form an ergonomically shaped grip and may be provided with a non-slippery surface, e.g. of a soft resilient polymeric material. The lock may preferably form part of, or be connected to the handle to enable movement between the locked and unlocked positions from outside the distance piece.

The first and second parts could be connected by an elastically deformable connection member exerting on the first and second parts a force towards the contracted relative position. The elastically deformable member could e.g. be one or more rubber bands. The first and second parts could also be moulded as one component forming a transition-zone being elastically deformable to allow the two parts to move in relation to each other.

The separation part could be adapted to rotate in the space or it could be adapted to move substantially linearly back and forth in the space. As an example, at least one of the first part, the second part and the separation part could be wedge shaped. By movement of the separation part back and forth in the space, displacement between one or more wedge shaped parts may cause the movement between the contracted and the expanded position.

To ensure movement of the separation part within specific limits in the space, at least one of the inner surfaces may have a groove forming a suspension for the separation part. The groove could have a shape which matches the shape of the separation part to fit tightly around the separation part. As an example, the groove could have a concave or a semi-circular shape when viewed in a cross sectional view perpendicular to the grove, and the separation part could correspondingly have a curved, e.g. a circular curved outer shape when viewed in a cross-section perpendicular to a longitudinal direction of the separation part.

In order to maintain the distance piece in its expanded state, a locking feature of the separation part cooperating with a locking feature of at least one of the first and second parts may be provided to enable locking of the separation part in the first position. The lock may comprise a locking surface portion of at least one of the first and second parts engaging a locking surface portion of the separation part. The locking surface portion could comprise an indented portion with a plurality of teeth, e.g. serrated teeth arranged on at least one of the parts and adapted to engage with corresponding serrated teeth arranged on the separation part. The cooperating indentations or similar means may in any case be adapted to lock movement of the separation part relative to the first and second parts. The provision of a plurality of indentations or protrusions on the separation part and/or on the first or second parts enables locking of the separation part in a plurality of positions relative to the first and second parts and thus enables variable distances between the outer surfaces of the first and second parts. Alternatively, or in combination, interference fit between the separation part and the first and second parts may lock movement of the separation part relative to the first and second parts. The separation part could have one position within the space wherein the locking surface portions engage each other and another position wherein they disengage each other. For that purpose, the separation part may in addition to the locking surface portion comprise an unlocking surface portion being smooth relative to the locking surface portion. By movement of the distance part between one position wherein the locking surface portion of the separation part is in contact with the locking surface portion of the first and/or the second part and one position wherein the unlocking surface portion of the separation part is in contact with the locking surface portion of the first and/or the second part, the distance piece may be locked and unlocked, respectively, in its expanded state. As an example, the separation part could be rotated between one position wherein the locking surfaces are in contact with each other and another position wherein the locking surface are not contact with each other. In an alternative embodiment, the distance piece may be provided for disposable use, i.e. wherein the separation part is locked permanently when brought into the first position so that the distance piece only can be brought from the contracted condition to the expanded condition one single time.

The locking surface portion of the first and/or second part could preferably be located in a groove in the inner surface of that part, and the groove could form an extension of the suspension groove. The groove of each part may, when viewed in a plane perpendicular to a longitudinal direction of the groove, form semi-circular shapes. When the inner surfaces face towards each other, the grooves form a circular bearing to receive a cylindrical oblong body part of the separation part.

To enable better pre-fixation of the distance piece in a gap between a building and a component, the outer surface of at least one of the first and second parts may comprise at least one resilient protrusion. Due to the resiliency of the protrusion, the distance piece could be inserted into the gap in the contracted state, in which state the protrusion provides a resilient filling out of the gap and thus holds the distance piece in place until the separation part is moved to the first position to shift the distance piece to the expanded state. In the expanded state, the protrusion is resiliently compressed towards the outer surface of the distance piece. To allow the resiliently compression towards the surface, the resilient protrusion may advantageously be located in a cavity of the surface.

One of the first and second parts may comprise means for receiving the other part so as to interlock the parts. If the first and second parts are wedge shaped, they may be in mutual contact and arranged reversely in respect to each other so that a sharp edge of the first wedge-formed element is pointing in the direction of a blunt edge of the second wedge-formed element.

Furthermore, the distance piece may comprise a guiding arrangement allowing the two parts to slide or move a certain distance relative to each other. Also, the guiding arrangement may comprise a stopping member for preventing the two elements from becoming separated from each other. The guiding arrangement may be implemented as an opening formed as a slit in one part, whereas the stopping member may be formed by the ends or only one end of this slit. The other part may be equipped with a nail adapted to fit onto the slit and slide along a longitudinal direction of the slit. The nail may have a head portion having a width exceeding the width of the nail itself. Also, the width of the head portion exceeds the width of the slit. Thus, the engagement of the nail into the slit keeps the first and second parts together and prevents that the two parts are separated from one another. In order for the head portion to engage into the slit, the slit may have an end region having a width exceeding the width of the slit. The width of this end region is sufficient to receive the head portion of the nail.

The distance piece may further comprise a connection element interconnecting the first and second parts. The connection element may serve several purposes. Firstly, the connection element prevents that the first and second parts become dislocated from each other. Secondly the connection element may serve as a handhold for the distance piece. Thirdly, the connection element may serve as a release mechanism in the situation where the first and second parts are positioned between two objects, such as between a wall and a wooden floor, or between a wall and a door or a window. After having arranged the final fixation between the two objects the user of the distance piece pulls the connection element causing the parts to release from their mutual engagement. A consequence of this disengagement is that the distance piece may be easily removed from the opening between the two objects. The first and second parts and the connection element may be made of the same material, preferably as a one-piece component. This material may be a polymer-based material, such as a plastic material.

In one embodiment, the locking means comprises surface portions of the first and second parts which abut cooperating surface portions of the separation part, wherein the abutting surface portions form an angle, α, with the first direction, and wherein a coefficient of friction, ρ, between abutting surfaces multiplied with sine to the angle α is larger than cosine to the angle α. This feature facilitates, that the separation part can be pressed from the second position towards the first position to expand the distance piece, and when the pressure is released, the separation part remains in its position without sliding back towards the second position. Various values of coefficients of friction may be obtained by various materials and/or surface treatments known in the art, and corresponding angles are selected to serve the stated purpose.

In another aspect, the invention provides the use of a device according to the invention.

### DETAILED DESCRIPTION OF THE INVENTION

In the following, the invention will be described in further details with reference to the drawing in which:

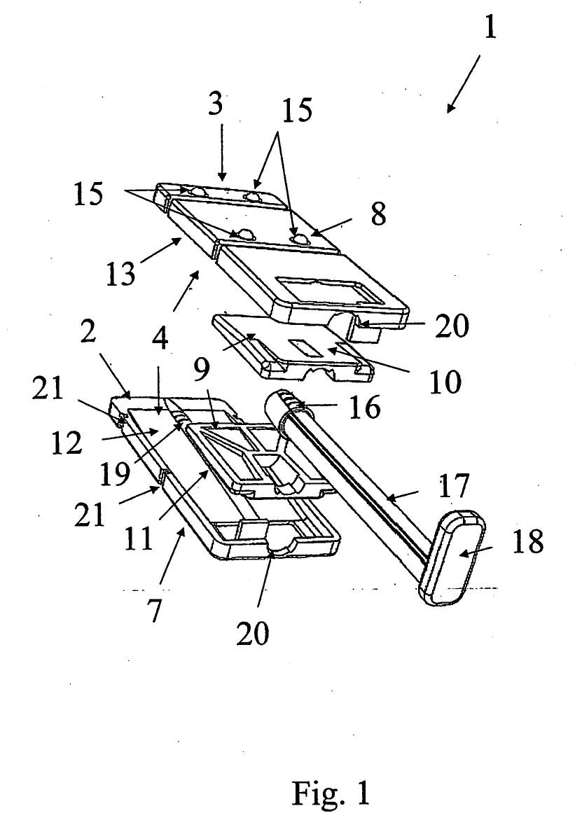

FIG. 1 shows a perspective, exploded view of a distance piece according to the invention,

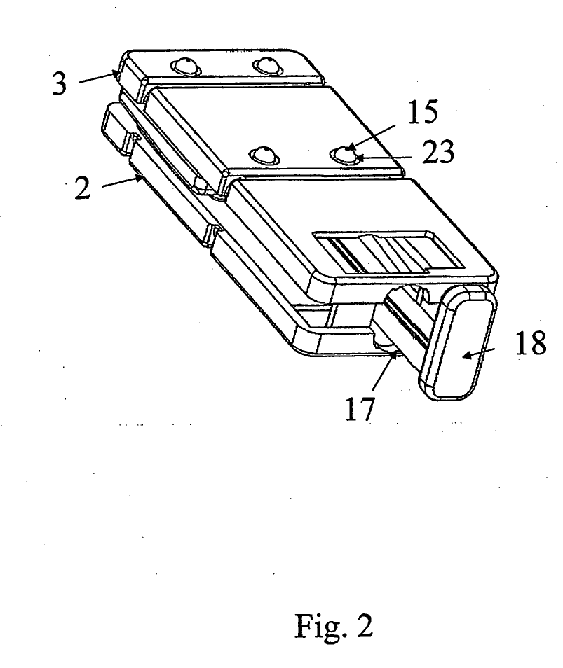

FIG. 2 shows a perspective view of the distance piece in a contracted configuration,

FIG. 3 shows a perspective view of the distance piece in an expanded configuration,

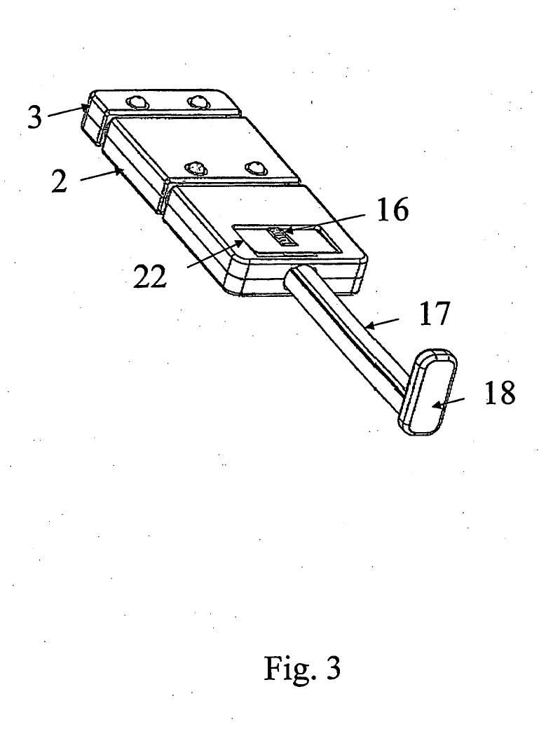

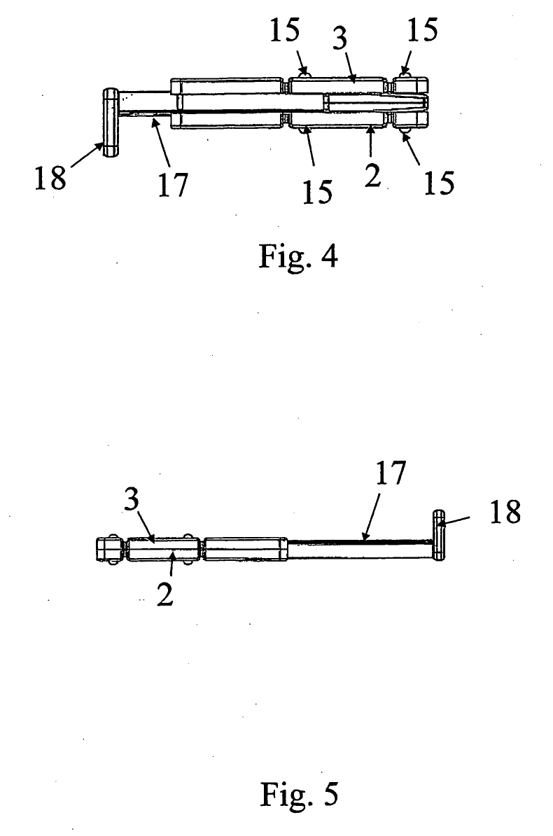

FIGS. 4 and 5 show side views of the distance piece in an expanded and contracted configuration, respectively,

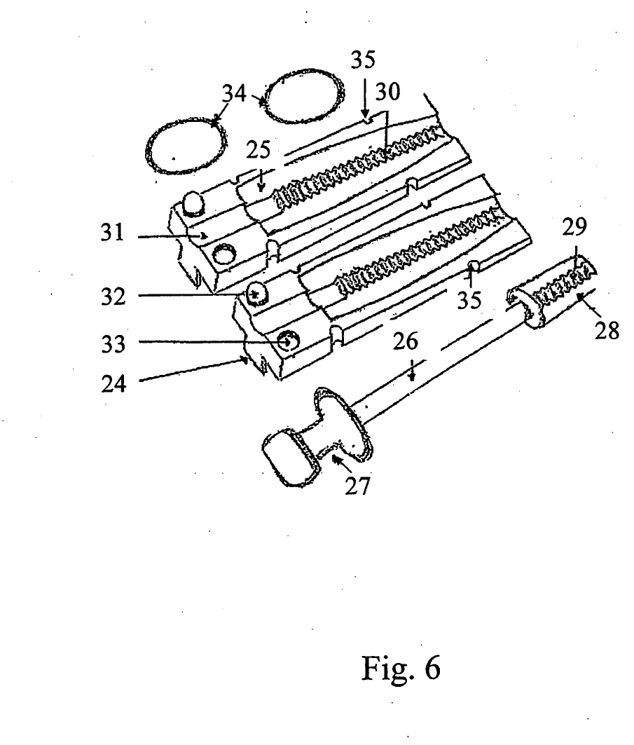

FIGS. 6-9 show an embodiment of the distance piece wherein the first and second parts are wedge shaped, and

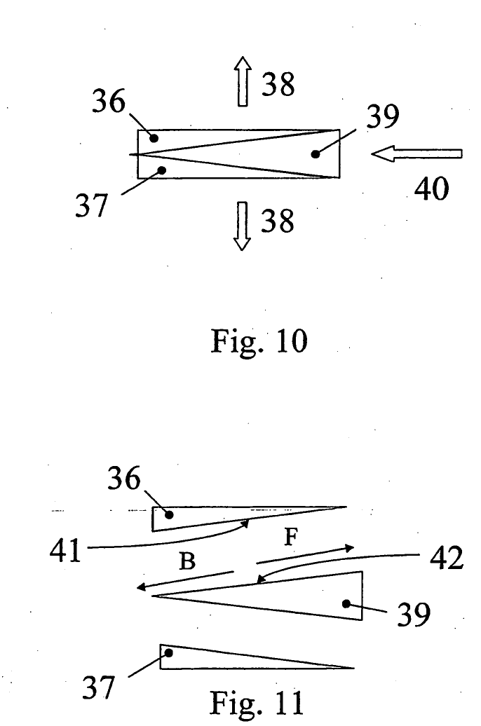

FIG. 10 shows diagrammatically abutting surfaces of the first part and the separation part.

As shown in FIG. 1, the distance piece comprises first and second parts 2, 3 having inner surfaces 4 (the inner surface of the second part is not visible in FIG. 1) facing towards each other. A space 6 is formed between the first and second parts, and in that space a separation part 9 with a set of first surface contact portions 10, 11 is arranged. The separation part 9 is movable between first and second positions in the space, and by movement of the separation part 9, the surface contact portions 10, 11 (one of the surface contact portions, cf. numeral 11, is on a lower surface of the separation part and is therefore not visible in FIG. 1) are moved between first and second positions in the space for interchangeably being in contact with and being out of contact with a corresponding set of second surface portions 12, 13 of the first and second parts (surface portion 13 is formed on the inner surface of the second part, i.e. facing downwardly, and is not visible in FIG. 1). The surface portions 12, 13 are elevated from the general plane of the inner surface to effectuate the expansion of the distance piece when the separation part is pushed forwardly and thus comes into contact with this surface part.

The outer surfaces 7, 8 (the outer surface 7 faces downwardly and is therefore not visible in FIG. 1) of the first and second parts 2, 3 form part of an outer surface of the distance piece. The outer surface comprises resilient protrusions 15 located in cavities of the surfaces. The separation part is adapted to move linearly in the space, to effect the movement of the set of first contact portions 10, 11 between the first and second positions in the space. The handle 17 extends outside the space and can be used to effectuate the linear movement of the separation part from outside the space. Due to the angled end portion 18 of the handle 17, the handle part of the separation part can be rotated between a locked position and an unlocked position. In the locked position, the locking surface portion 16 of the separation part engages the locking surface portion 19 of the first part 2. In the unlocked position, the locking surface portion 16 is offset from the locking surface portion 19. Since the two surface portions do not engage each other, the separation part is free to move linearly back and forth in the space. For this movement, the suspension groove 20 forms a suspension for the separation part. The locking surface portions 16, 19 comprise indented surfaces wherein indentations of one of the portions can be engaged by indentations of the other portion.

To exert a force on the first and second parts to move towards each other, when they are not kept in the expanded condition by the separation part, the first and second parts are connected by an elastically deformable connection member, e.g. a rubber band. The two circumferentially extending grooves 21 serve to fixate two of such rubber bands in place.

In operation, the distance piece is inserted into a gap between a building component and a building, e.g. between a gap in a wall and a window frame. To position and fixate the window frame, the separation part 9 is pushed into the space whereby the first and second parts are pressed apart, i.e. the first and second parts move relative to each other between a contracted relative position with a shorter distance between the outer surfaces and an expanded relative position with a larger distance between the outer surfaces. In the second position, the separation part is locked by the engagement between the locking surface portions 18, 19.

In FIG. 2, it is clearly seen that the protrusions 15 are located in cavities.

In FIG. 3, it is shown how the locking surface portion 16 locks the distance piece in its contracted position by catching an edge of the opening 22.

In FIGS. 4 and 5, it is shown that the contracted relative position between the first and second parts 2, 3 provides a shorter distance between the outer surfaces, c.f. FIG. 5, and that the expanded relative position between the first and second parts provides a larger distance between the outer surfaces, c.f. FIG. 4. In FIGS. 4 and 5, it is further shown, that the protrusions 15 could be made on the outer surface of both the first and the second part.

FIGS. 6-9 show views of one embodiment of a distance piece comprising wedge shaped parts. The distance piece according to this embodiment comprises a first and a second wedge shaped part 24, 25. To lower the manufacturing costs, these two parts could be identical parts. The separation part comprises an elongated shaft portion 26 which is cylindrical. At one end, the separation part comprises a handle 27 and in its opposite end, a head 28 with an indented locking surface portion 29. When the separation part is arranged between the first and second parts, the elongated shaft portion is received by the recess 31 formed both in the first and the second parts. The recess allows the separation part to slide back and forth in the space between the first and the second parts. In one, locked, position of the head relative to the locking surface portion 30 of the first and/or second part, the separation part is prevented from sliding out of the space and thus keeps the distance piece in a fully or at least partly expanded condition. When the separation part is rotated, the locking surface portion 29 of the separation part and the locking surface portion 30 of the first and/or second part disengage and the separation part can be pulled at least partly out of the space whereby the distance piece collapse. To press the first and second parts towards the collapsed condition, the distance piece comprises two rubber bands 34 which are fixated in the circumferentially extending grooves 35. The first and second parts comprises an outwardly extending protrusion 32 and an inwardly extending depression 33 provided to engage the opposite feature of the mating part of a distance piece and thus to keep the first and second parts in fixed position above each other.

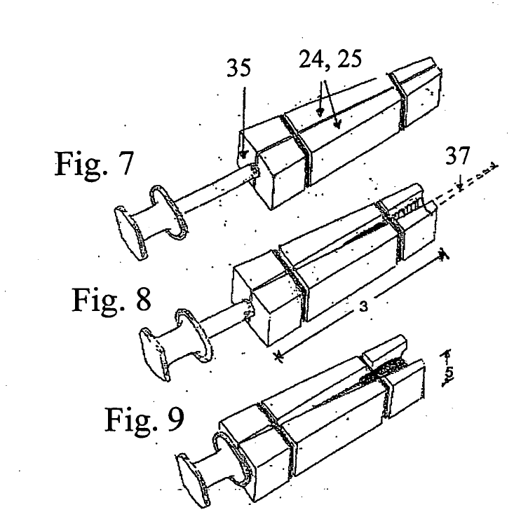

FIG. 7 shows the distance piece of FIG. 6 in a collapsed condition, FIG. 8 shows the distance piece in a partly expanded condition, and FIG. 9 shows the distance piece in a completely expanded condition.

FIG. 10 shows a simple and reliable embodiment of the distance piece wherein the first and second parts 36, 37 are moved toward the expanded position in the direction of the arrows 38 when the separation part 39 is moved in the direction of the arrow 40. In this embodiment, the locking means is constituted by surface portions of the first and second parts which abut cooperating surface portions of the separation part. The surfaces are provided with a coefficient of friction and the angles of the surfaces to the direction of movement of the separation part (symbolised by the arrow 40) is chosen so that the separation part can be pressed in the direction of the arrow 40 without sliding back when the pressure is released.

In FIG. 11, the distance piece in FIG. 10 is shown in an exploded view. The surface 41 which abut a cooperating surface 42 of the separation part 39. The frictional force is symbolised by the arrow F and the angle between the abutting surfaces and the direction of movement of the separation part relative to the first and second parts is symbolised by the sign, α.

To ensure that the separation part does not slide back when the pressure in the direction of the arrow 40 is released, the frictional force F must be larger than the oppositely directed force symbolised by the arrow B. This requires that:

ρ*sin α≧cos α

wherein:
ρ: is the coefficient of friction between the surfaces, and
α: is the angle between the surface and the direction of movement of the separation part relative to the first and second parts.

1. A distance piece comprising:
first and second parts having inner surfaces facing towards each other, and outer surfaces forming part of an outer surface of the distance piece, the parts being movable relative to each other between a contracted relative position with a shorter distance between the outer surfaces and an expanded relative position with a larger distance between the outer surfaces,
a separation part located between the first and second parts, and being movable in a first direction between a first position relative to the first and second parts wherein the separation part forces the first and second parts towards the expanded relative position and a second position relative to the first and second parts wherein the first and second parts are allowed to move to the contracted relative position, and
locking means for hindering movement of the separation part from the first position to the second position relative to the first and second parts,
wherein locking means comprises at least one configuration in which it permits movement of the separation part from the second position to the first position relative to the first and second parts.

2. A distance piece according to claim 1, wherein the locking means comprises a lock which is movable between a locked position wherein it hinders the movement of the separation part relative to the first and second parts and an unlocked position wherein it does not influence the movement of the separation part relative to the first and second parts.

2. A distance piece according to claim 1, wherein the lock forms part of the separation part

3. A distance piece according to claim 2, wherein the separation part comprises a handle extending outside the space to effectuate the movement of the separation part from outside the space.

4. A distance piece according to claim 3, wherein the lock forms part of the handle to enable movement of the lock between the first and second position from outside the space.

5. A distance piece according to claim 1, wherein the first and second parts are connected by an elastically deformable connection member exerting on the first and second parts a force towards the contracted relative position.

6. A distance piece according to claim 1, wherein at least one of the inner surfaces comprises a suspension groove forming a suspension for the separation part.

7. A distance piece according to claim 1, wherein the lock comprises a locking surface portion of at least one of the first and second parts engaging a locking surface portion of the separation part.

8. A distance piece according to claim 7, wherein at least one of the locking surface portions comprises at least one protrusion.

9. A distance piece according to claim 8, wherein the at least one protrusion forms part of an indented surface.

10. A distance piece according to claim 7, wherein the locking surface portion of the first and/or second part is located in a groove in the inner surface of that part.

11. A distance piece according to claim 10, wherein the groove forms an extension of the suspension groove.

12. A distance piece according to claim 7, wherein the separation part in addition to the locking surface portion comprises an unlocking surface portion being smooth relative to the locking surface portion.

13. A distance piece according to claim 12, wherein the locking surface portion of the separation part is in contact with the locking surface portion of the first and/or the second part in the locked position of the lock, and wherein the unlocking surface portion of the separation part is in contact with the locking surface portion of the first and/or the second part in the unlocked position of the lock.

14. A distance piece according to claim 13, wherein the locking surface portion of the separation part is adapted to rotate relative to the first and second parts between the locked position and the unlocked position.

15. A distance piece according to claim 1, wherein at least one of the first part, the second part and the separation part is wedge shaped.

16. A distance piece according to claim 1, wherein the outer surface of at least one of the first and second parts comprises at least one resilient protrusion.

17. A distance piece according to claim 16, wherein the resilient protrusion is located in a cavity of the surface.

18. A distance piece according to claim 1, wherein the locking means comprises surface portions of the first and second parts which abut cooperating surface portions of the separation part, wherein the abutting surface portions form an angle, α, with the first direction, and wherein a coefficient of friction, ρ, between abutting surfaces multiplied with sine to the angle α is larger than cosine to the angle α.
